(19) United States
(12) Patent Application Publication
(10) Pub. No.: US 2008/0300885 A1
(43) Pub. Date: Dec. 4, 2008

(54) Speech communication system for patients having difficulty in speaking or writing

(76) Inventors: Chung-Hung Shih, Taipei (TW); Ching-An Liaw, Hsin-Chu (TW)

Correspondence Address: BACON & THOMAS, PLLC, 625 SLATERS LANE, FOURTH FLOOR, ALEXANDRIA, VA, 22314-1176, US

(21) Appl. No.: 11/907,312

(22) Filed: Oct. 11, 2007

(30) Foreign Application Priority Data
May 30, 2007 (TW) 096119310

(51) Int. Cl. G10L 21/06

(52) U.S. Cl. 704/271

(57) ABSTRACT

A speech communication system for patients having difficulty in speaking or writing comprises a display screen, a controller, a host having a storage unit for storing specific software and connected with the display screen, and a speaker connected with the host. A plurality of choices is presented on the display screen in a nine-square form or an English keyboard form for patients to select according to their needs. The controller is used for patients having difficulty in speaking or writing to move a cursor on the display screen to select any choice they need. The speaker is designed to output speech sounds of words or simple sentences in different languages corresponding to the choices patients select via the controller and thus make it possible for patients to communicate with others.

### BACKGROUND OF THE INVENTION

1. Field of the Invention

The present invention relates to a communication system used for critically ill patients or patients with nervous system diseases and, more particularly, to a speech communication system for patients having difficulty in speaking or writing, which includes a simple controller and a speaker for helping the patients who fail to speak or write communicate with their family members or medical staff.

2. Description of the Prior Art

Patients having difficulty in speaking or writing in intensive care units of hospitals usually call the medical staff to get help via an alarming clinical device. As shown in FIG. 10, if necessary, patients can call the medical staff by pressing a button of the calling-bell “a11” provided on the side of bed “a10”. When a patient presses the button of the calling-bell “a11”, medical staff will give the patient appropriate treatment according to the symptoms of the patient only if the patient has obvious symptoms, such as seizure, dyspnea, or other apparent symptoms. If the patient has some requests or problems rather than symptoms or has non-obvious symptoms, it will be difficult for medical staff to understand what the patient wants or to judge what troubles the patient currently. For example, an emotional problem will be hard to solve if the medical staff cannot understand what the problem is. Under this condition, medical staff can do nothing but guess what the patient need when facing the patient who needs help eagerly.

The problem mentioned above has been tried to be solved by using booklets printed with possible situational pictures for communication between patients and the medical staffs. The number of different situational pictures able to be printed in a booklet is limited while the clinical needs of patients are numerous, so it is impossible to include all possible needs of patients in a booklet. Besides, it is nearly impossible for paralyzed patients to point at a certain situational picture by using their fingers. Therefore, patients can only select the situational picture by shaking or nodding the head to confirm the picture pointed by the fingers of medical staff, and it is time consuming and inefficient.

Moreover, though the recovered patients at home can communicate with their family members who take care of the patients by using the alarming devices or the booklets printed with situational pictures mentioned above, it is also difficult for patients to communicate with their family members because of the disadvantages mentioned above. Thereby, their family members can only try hard to understand what the patients want to express by guessing.

Patients who are conscious but have difficulty in speaking or writing have a variety of physical or mental problems or needs. If their medical staff or family members cannot take care and satisfy various problems and needs of the patients due to failing to know what the patients want to express, the effect of medication or the quality of the lives of the patients will be affected greatly. The problems of the patients can be classified into two types: an emotional type and a physical type. The physical problems may include the discomfort resulting from rude tracheal intubations, phlegm sucking, nausea, chest distress, palpitation, wound pain, itching skin, or other non-obvious symptoms. If these physical problems cannot be solved, the diseased patients will be further afflicted. Moreover, these patients also have certain emotional problems and need someone else to listen and understand their feelings. For example, they may want to change the type of treatment adopted currently, to see a certain family member eagerly, to write a will or make some arrangements in advance, or to just express their distress or suffering. Besides, the non-obvious physical problems are difficult to be perceived while the emotional problems are even more difficult to be understood. Therefore, the patients will suffer both the physical and the emotional affliction at the same time and the double afflictions will adversely affect the effect of treatment and the quality of their lives.

In order to solve the problems mentioned above to provide a speech communication system for patients having difficulty in speaking or writing to make it possible for the patients to express what they need clearly and communicate with others without obstructions, inventor had the motive to study and develop the present invention after hard research.

### SUMMARY OF THE INVENTION

The main object of the present invention is to provide a speech communication system for patients having difficulty in speaking or writing to express what they need clearly and to communicate with others without obstructions.

In order to achieve the above object, the present invention provides a speech communication system for patients having difficulty in speaking or writing, which comprises a display screen, a controller, a host having a storage unit for storing specific software and connected with the display screen, and a speaker connected with the host. A plurality of choices is presented on the display screen in a nine-square form and each choice is related with a piece of information for patients to select according to their needs. The controller is used for patients having difficulty in speaking or writing to move a cursor on the display screen to select any choice they need. The speaker is designed to output speech sounds of words or simple sentences according to the choices patients select via the controller and thus make it possible for patients to communicate with others.

The following detailed description, given by way of examples and not intended to limit the invention solely to the embodiments described herein, will best be understood in conjunction with the accompanying drawings.

### BRIEF DESCRIPTION OF THE DRAWINGS

FIG. 1 is a schematic view of a speech communication system for patients having difficulty in speaking or writing of the present invention.

FIG. 2 shows a using state diagram of a first embodiment of the present invention.

FIG. 3 is a schematic view of the first embodiment of the present invention showing a nine-square set on a display screen.

FIG. 4 is a schematic view of a second embodiment of the present invention showing another kind of a display screen.

FIG. 5 is a schematic view of a third embodiment of the present invention showing another kind of a display screen.

FIG. 6 is a schematic view of a fourth embodiment of the present invention showing another kind of a display screen.

FIG. 7 is a schematic view of a fifth embodiment of the present invention showing another kind of a display screen.

FIG. 8 is a using state diagram of the fifth embodiment of the present invention.

FIG. 9 is a using state diagram of a sixth embodiment of the present invention.

FIG. 10 shows a calling-bell used in a ward of prior art.

### DETAILED DESCRIPTION OF THE PREFERRED EMBODIMENTS

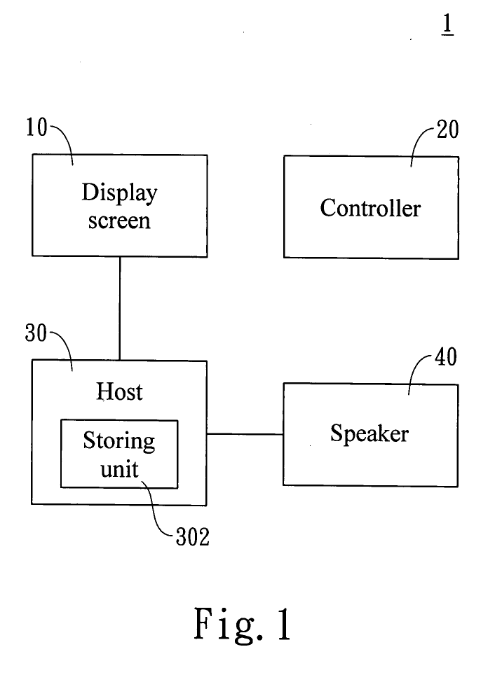

The present invention provides a speech communication system 1 for patients having difficulty in speaking or writing to help the patients unable to speak or write communicate with their medical staff or family members to express their emotional feelings or what they need. As shown in FIG. 1, the speech communication system 1 comprises a display screen 10, a controller 20, a host 30 connected with the display screen 10 and a speaker 40 connected with the host 30. The host 30 has a storage unit 302 for storing specific software. A plurality of choices is presented on the display screen 10 for patients to select. The controller 20 is used for patients to move a cursor on the display screen to select any choice they need. The speaker 40 is designed to output speech sounds of words or simple sentences in different languages according to the choices patients select and thus make it possible for patients to communicate with others.

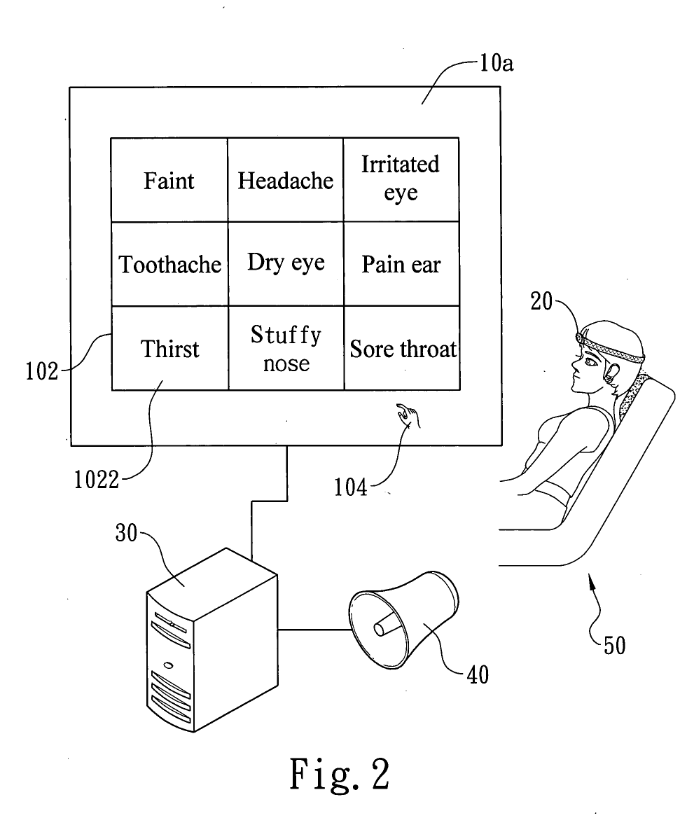

FIG. 2 shows a using state diagram of a first embodiment according to the present invention. As shown in FIG. 2, the display screen 10a of the speech communication system 1 of the first embodiment according to the present invention is presented with a nine-square set 102 thereon and each square 1022 of the nine-square set 102 is provided with a choice representing a piece of information for patients to select. For example, the nine squares 1022 in this embodiment respectively are presented with words corresponding to respective pieces of information, such as “Faint”, “Headache”, “Irritated eye”, “Toothache”, “Pain ear”, “Thirst”, “Stuffy nose”, and “Sore throat”. If the problem of a patient 50 is presented in one of the nine squares 1022, the patient 50 can move a cursor 104 on the display screen 10a toward one square 1022 corresponding to the problem of the patient via the controller 20. When the cursor 104 is moved to the square 1022 the patient needs, a speech sound corresponding to the piece of the information that is selected by the patient 50 can be sent out via the speaker 40. For example, if the patient 50 selects information concerning “Headache”, a speech sound of “Headache” will be sent out for the patient 50 to express the problem she or he confronts.

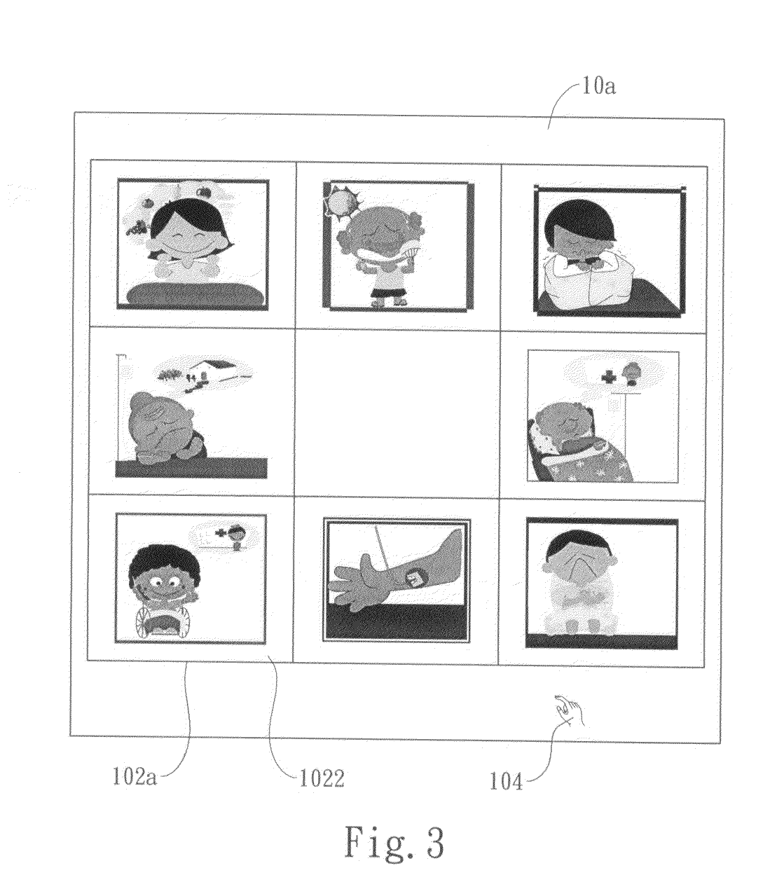

Moreover, the pieces of information in the nine squares 1022 of the nine-square set 102 can be presented in the form of corresponding pictures or situational cartoons besides written words. As shown in FIG. 3, situational cartoons corresponding to the pieces of information are presented on the display screen 10a, so that it is more convenient for patients to understand what the choices represent.

As shown in FIG. 2, the controller 20 in the first embodiment is a head-mounted wireless mouse for patients to move the cursor 104 by means of head movement. Besides, the controller 20 also can be a wireless mouse, a touch screen disposed in the display screen, or a usual mouse. The display screen 10a can be a liquid crystal screen. It is preferably to arrange relevant pieces of information in the same nine-square set 102. For example, all the pieces of information in FIG. 2 are relevant symptoms of head.

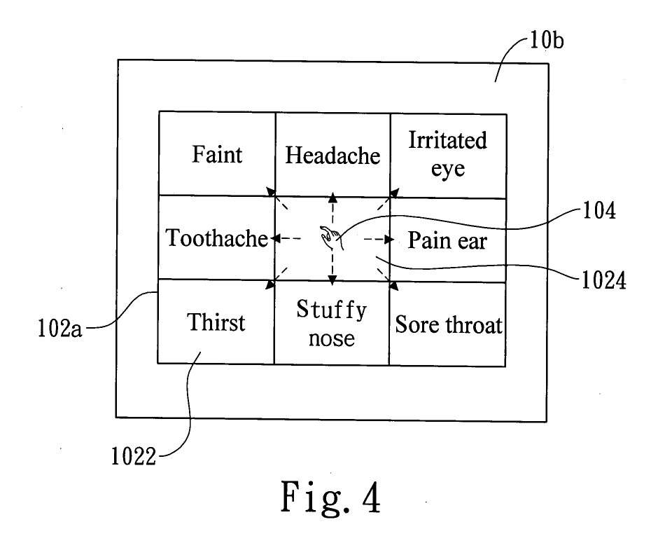

FIG. 4 is a schematic view of a second embodiment according to the present invention. For the purpose of describing this embodiment conveniently, we will assign the same structure with the same number used in the first embodiment. Compared with the first embodiment, a nine-square set 102a on a display screen 10b in the second embodiment is provided with a resting square 1024 centrally for resting the cursor 104 thereon without sending out any speech sound. Referring to the FIG. 2 of the first embodiment, if a patient wants to select the square 1022 of “Faint”, the patient will have to move the cursor 104 from its original position, the square 1022 of “Sore throat”, to the square 1022 of “Faint”. If the patient directly moves the cursor 104 in a diagonal direction, other squares may be activated to send out speech sounds and it may interfere the understanding of medical staff or the patient's family members. Thus, in order to prevent misunderstanding, the patient has to move the cursor 104 carefully along the peripheral areas outside the squares toward the square selected by the patient and it is very inconvenient. Therefore, by providing the resting square 1024 in the second embodiment, the patient can rest the cursor 104 on the resting square 1024 or move the cursor along arrow directions toward the square selected by the patient according to the patient's need. When the cursor 104 is moved to the selected square, a corresponding speech sound will be sent out by the speaker 40.

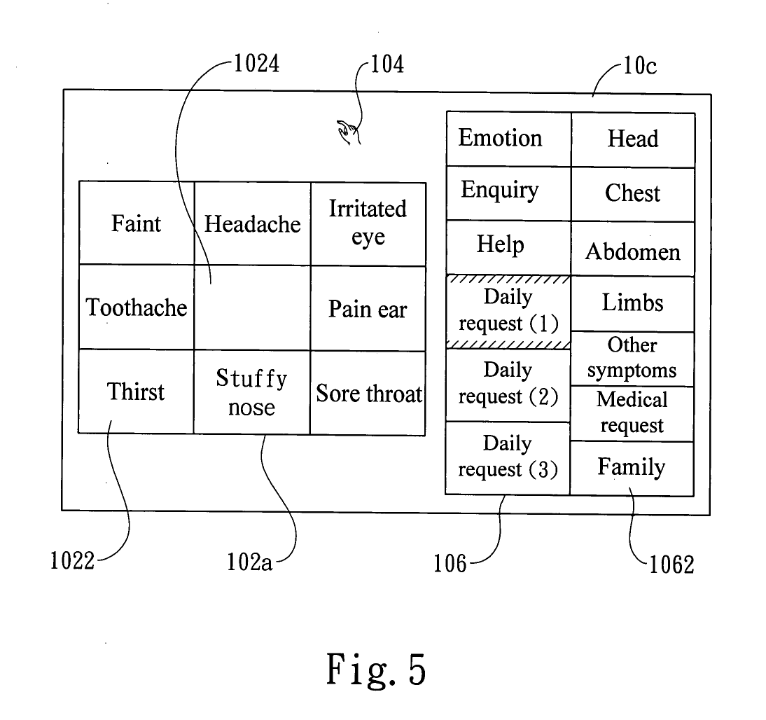

FIG. 5 is a schematic view of a third embodiment according to the present invention. For the purpose of describing this embodiment conveniently, we will assign the same structure with the same number used in the second embodiment. Compared with the second embodiment, a set of main choices 106 in longitudinal arrangement is provided on a display screen 10c in the third embodiment. In this embodiment, the set of main choices 106 includes thirteen main choices 1062, which respectively represent “Head”, “Chest”, “Abdomen”, “Limbs”, “Other symptoms”, “Medical request”, “Family”, “Emotion”, “Enquiry”, “Help”, “Daily request (1)”, “Daily request (2)”, and “Daily request (3)”. These main choices 1062 can be presented in written words, pictures, or situational cartoons. Each main choice 1062 corresponds to a nine-square set 102a. For example, if the patient moves the cursor 104 to the main choice 1062 of “Head”, a corresponding nine-square set 102a will be presented on the display screen 10c, wherein the nine-square set 102a includes one resting square 1024 and eight squares 1022 concerning pieces of information “Faint”, “Headache”, “Irritated eye”, “Toothache”, “Pain ear”, “Thirst”, “Stuffy nose”, and “Sore throat”. In addition to the main choice “Head” mentioned above, each of other main choices corresponds to one nine-square set including pieces of information that are relevant and of high incidence clinically. The pieces of information in a nine-square set corresponding to the main choice 1062 “Chest” are “Sore neck”, “Pain neck”, “Sore shoulder”, “Pain shoulder”, “Chest distress”, “Asthma”, “Chest pain”, and “Palpitation”. The pieces of information in a nine-square set corresponding to the main choice 1062 “Abdomen” are “Hiccough”, “Abdominal pain”, “Hungry”, “Abdominal distention”, “Diarrhea”, “Nausea”, “Constipation”, and “Inappetence”. The pieces of information in a nine-square set corresponding to the main choice 1062 “Limbs” are “Hand pain”, “Sore hand”, “Foot pain”, “Sore foot”, “Foot numbness”, “Backache”, “Waist ache”, and “Sore waist”. The pieces of information in a nine-square set corresponding to the main choice 1062 “Other symptoms” are “Weak”, “Cold”, “Hot”, “Itching skin”, “Wound pain”, “Pain during urinating pain”, “Pain during defecating”, and “Swollen limbs”. The pieces of information in a nine-square set corresponding to the main choice 1062 “Medical Request” are “Call doctor”, “Try best medicine”, “Try Chinese herbs”, “Try acupuncture”, “No tracheal incision”, “No injection”, “No blood-taking”, and “Hospital transfer”. The pieces of information in a nine-square set corresponding to the main choice 1062 “Family” are “Call my wife”, “Call my daughter”, “Call my son”, “Go home”, “Be with Dad”, “Be with Mom”, “Be with children”, and “Stay with family”. The pieces of information in a nine-square set corresponding to the main choice 1062 “Emotion” are “Depressive”, “Insomnia”, “Angry”, “Cheerful”, “Want to die”, “I'm okay”, “Don't be sad”, and “I'll try my best”. The pieces of information in a nine-square set corresponding to the main choice 1062 “Enquiry” are “What's date today”, “What's time now”, “When can I leave hospital”, When to take out tube”, “When can I go home”, “Problem in the home”, “When I take medicine”, and “Any family member here”. The pieces of information in a nine-square set corresponding to the main choice 1062 “Help” are “Wash hair”, “Haircut”, “Phlegm sucking”, “Remove the tube”, “Need blanket”, “Need massage”, “Heighten legs”, and “Change diaper”. The pieces of information in a nine-square set corresponding to the main choice 1062 “Daily Request (1)” are “Prefer a meal”, “Prefer soup”, “Prefer fruit”, “Prefer juice”, “Toilet”, “Want to piss”, “Wipe nasal dirt”, and “Shower”. The pieces of information in a nine-square set corresponding to the main choice 1062 “Daily Request (2)” are “Turn on air conditioner”, “Turn on fan”, “Want to write”, “Want to sleep”, “Read books”, “Read newspapers”, “Listen to music”, and “Watch TV”. The pieces of information in a nine-square set corresponding to the main choice 1062 “Daily Request (3)” are “Wear cloth”, “Want to sit”, “Want to lie down”, “Raise bed-head”, “Too light”, “Low bed-head”, “Too noisy”, and “Too dark”.

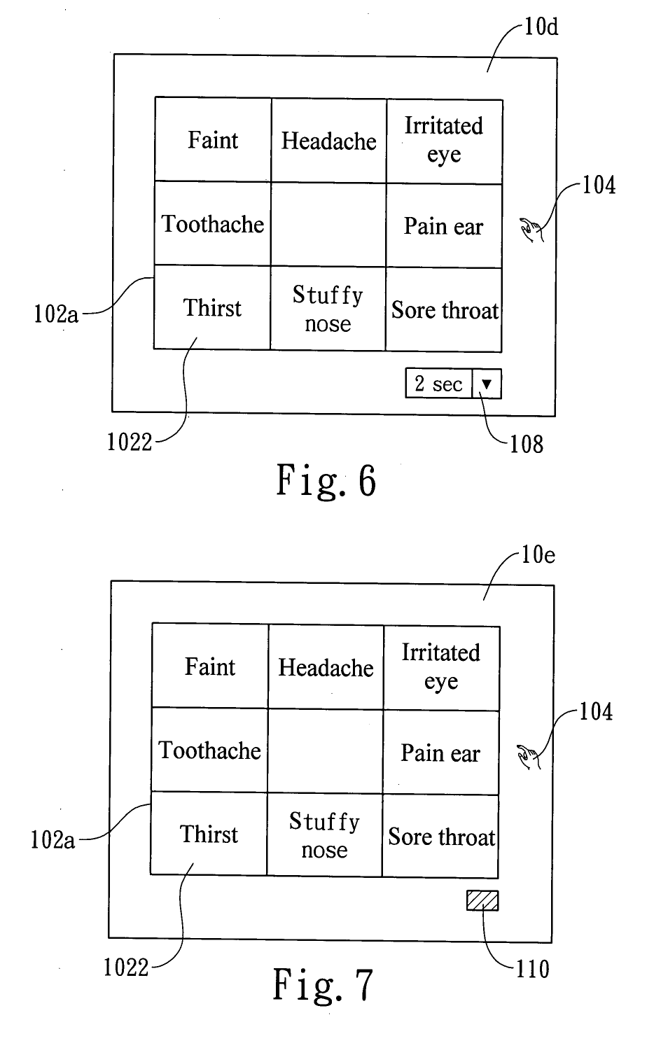

FIG. 6 is a schematic view of a fourth embodiment according to the present invention. For the purpose of describing this embodiment conveniently, we will assign the same structure with the same number used in the second embodiment. Compared with the second embodiment, a time-delay choice 108 for delaying sending out a speech sound is presented on a display screen 10d of the fourth embodiment. For example, if a patient selects “2 seconds” in the time-delay choice 108, a speech sound will only be sent out by the speaker 40 only when the cursor 104 is moved to a selected square and stayed on that selected square for 2 seconds. By this design, if a patient wants to move the cursor 104 to bottom-left square from its original top-right square, the patient can move the cursor 104 directly toward the target square in diagonal direction without accidentally making any sound from one square that the patient doesn't want to select.

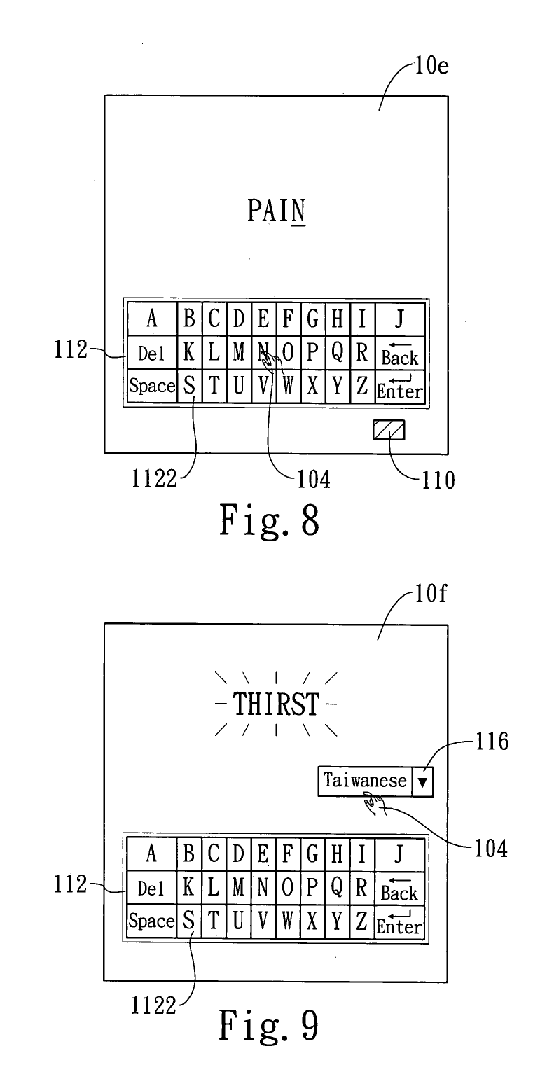

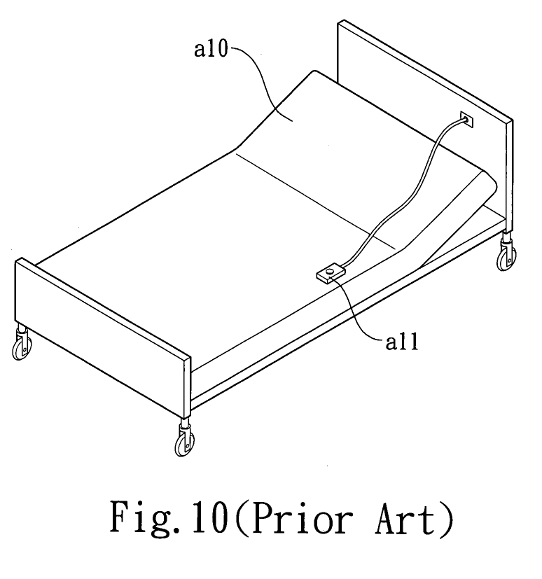

FIG. 7 is a schematic view of a fifth embodiment according to the present invention. As shown in FIG. 7, a mode-selection choice 110 for a patient to change the nine-square mode into a simplified keyboard form is presented on a display screen 10e of the fifth embodiment. FIG. 8 is a using state diagram of the fifth embodiment and shows that an English keyboard 112 is presented on the display screen 10e after patients change the nine-square mode to the English keyboard mode by selecting the mode-selection choice 110. The English keyboard 112 presented on the display screen 10e has a plurality of keys 1122, which include alphabetical keys, a space key, a backspace key, a delete key, and a enter key. When in practice, a patient can select the keys 1122 of the keyboard 112 by moving the cursor 104 on the display screen 10e via the controller 20 to input English letters, for example, “pain” shown in FIG. 8. After inputting letters, the patient can press the enter key and a speech sound corresponding to what the patient inputs, such as a word or a simple sentence, will be sent out by the speaker 40.

Besides, patients can use the alphabetical keys as phonetic symbols to form a word or a sentence that has the same pronunciation of a non-English word or simple sentence. For example, a patient can input Chinese phonetic spelling words “Tou Tong” that has the same meaning of “Headache” and make it send out by the speaker 40. Moreover, the alphabetical keys of the keyboard 112 can be replaced by phonetic notations of any languages, such as Chinese, Thai, Japanese, Korean, or European languages, for patients to input.

FIG. 9 is a schematic view of a sixth embodiment according to the present invention. For the purpose of describing this embodiment conveniently, we will assign the same structure with the same number used in the fifth embodiment. Compared with the fifth embodiment, a language choice 116 is presented on a display screen 10f in the sixth embodiment for patients to select the kind of languages for outputting sounds. For example, as shown in FIG. 9, a patient can input English word “Thirst” but make the speaker 40 send out a Taiwanese speech sound having the same meaning of “Thirst” by selecting “Taiwanese” in the language choice 116. Accordingly, the language of input words or simple sentences and the language of the output speech sound can be different. That is, a patient can input Chinese characters or simple sentences but make the speaker 40 send out corresponding speech sounds in English, Japanese, Korean, or European languages. Besides, if a patient input Chinese words or simple sentences, corresponding sounds also can be sent out in different Chinese dialects.

Accordingly, as disclosed in the above description and attached drawings, the present invention can provide a speech communication system for patients having difficulty in speaking or writing to make it possible for the patients to express what they need clearly and communicate with others without obstructions. It is new and can be put into industrial use.

It should be understood that different modifications and variations could be made from the disclosures of the present invention by the people familiar in the art, which should be deemed without departing the spirit of the present invention.

What is claimed is:

1. A speech communication system for patients having difficulty in speaking or writing, comprising:
a display screen showing a plurality of choices to form a nine-square set thereon, where each of the nine squares is provided with a piece of information for patients to select;
a controller used for a patient having difficulty in speaking or writing to move a cursor on the display screen to select a choice according to their needs;
a host having a storage unit for storing specific software and connected with the display screen; and
a speaker connected with the host for giving off the sound corresponding to a piece of information selected by a patient so that the patient is able to communicate with others.

2. The speech communication system for patients having difficulty in speaking or writing as claimed in claim 1, wherein the controller is a wireless head-mounted mouse, a wireless mouse, or a usual mouse for controlling the movement of the cursor.

3. The speech communication system for patients having difficulty in speaking or writing as claimed in claim 1, wherein the controller is a touch screen.

4. The speech communication system for patients having difficulty in speaking or writing as claimed in claim 1, wherein the pieces of information in the nine squares are presented in forms of figures, patterns, or situational cartoons.

5. The speech communication system for patients having difficulty in speaking or writing as claimed in claim 1, wherein when the cursor is moved to the square that a patient selects, a corresponding sound is sent out via the speaker.

6. The speech communication system for patients having difficulty in speaking or writing as claimed in claim 1, wherein the central square of the nine squares is a resting square for resting the cursor thereon without giving off sound.

7. The speech communication system for patients having difficulty in speaking or writing as claimed in claim 6, wherein a time-delay choice is further presented on the display screen for delaying the speaker sending out sound, where the sound is sent out only when the cursor is moved to and stayed on a selected square for a short while.

8. The speech communication system for patients having difficulty in speaking or writing as claimed in claim 1, wherein a group of plural main choices is further presented on the display screen for patients to change different sets of nine squares according to their needs.

9. The speech communication system for patients having difficulty in speaking or writing as claimed in claim 8, wherein the main choices are presented in forms of figures, patterns, or situational cartoons.

10. The speech communication system for patients having difficulty in speaking or writing as claimed in claim 1, wherein a mode-selection choice is further presented on the display screen for switching the nine-square mode into a simplified keyboard mode for patients to input.

11. The speech communication system for patients having difficulty in speaking or writing as claimed in claim 10, wherein the simplified keyboard is an English keyboard.

12. The speech communication system for patients having difficulty in speaking or writing as claimed in claim 1, wherein a language output choice is further presented on the display screen for patients to select a kind of languages of the sound sent out by the speaker.

13. The speech communication system for patients having difficulty in speaking or writing as claimed in claim 1, wherein the display screen is a touch liquid crystal display screen.
